(19) United States
(12) Patent Application Publication
(10) Pub. No.: US 2012/0234175 A1
(43) Pub. Date: Sep. 20, 2012

(54) GOOD SMELLING SCENTED AIR FILTER

(76) Inventor: MAZAL SANCHEZ, North Miami Beach, FL (US)

(21) Appl. No.: 13/052,046

(22) Filed: Mar. 19, 2011

(51) Int. Cl. B01D 46/00

(52) U.S. Cl. 96/222

(57) ABSTRACT

A good smelling scented air filter includes a frame member. A central fibrous filtering material pad is carried within the frame member. A pair of infused fragrance pads is sandwiched between the central fibrous filtering material pad. A pair of backing sheets is also are provided. Each sheet has a plurality of circular openings to allow forced air therethrough. Each sheet is placed over one of the infused fragrance pads to prevent deflection and defibrillation thereof, whereby the forced air can absorb the fragrance from the fragrance pads.

### CROSS-REFERENCE TO RELATED APPLICATION

This application claims the benefit of Provisional Patent Application No. 61/315,033, filed on Mar. 18, 2010, In the United States Patent & Trademark Office, the disclosure of which is incorporated herein by reference.

### BACKGROUND OF THE INVENTION

1. Field of the Invention

The present invention relates to an air filter, and more particularly, a scented air filter.

Scented candles, spray cans or potpourri may help mask odors in small areas, but there is an all-encompassing solution for the whole house if it has a forced-air heating system. Put the scented air filter on a furnace filter frame or in a motor vehicle. The system's blower will then spread the sweet smell throughout the house or the motor vehicle. If the heat's not on set the system on fan only.

The scented air filter allows scented air to continuously flow through a home, office, hotel, or other building. The present invention virtually eliminates the need to use candles or aerosol fragrances to cover up odors and keep the atmosphere fresh and clean. The scented air filter may be installed within an A/C system to freshen the circulated air throughout an entire home or building.

2. Description of the Prior Art

The air in homes and other buildings can often smell stale. To cover up certain odors or to simply freshen a room one may spray air fresheners. These items may solve the problem for a few minutes, but may then become undetectable. Aerosol air fresheners are also known to be damaging to the environment. Many individuals purchase scented candles to cover up the smell of smoke, pets, or other scents. A candle has a tendency to burn down after several uses and it can become costly to continuously replace the candles. A more efficient way is needed.

Numerous innovations for air freshening systems have been provided in the prior art that will be described. Even though these innovations may be suitable for the specific individual purposes to which they address, however, they differ from the present invention.

A FIRST EXAMPLE, U.S. Pat. No. 4,159,672, Issued on Jul. 3, 1979, to Garguilo et al. teaches an apparatus for introducing a scent into a forced air temperature changing system of the type having a blower and an air filter positioned upstream of the blower. The apparatus comprises a container for retaining a fluid having the desired scent. A spray device is positioned adjacent the filter and is connected to the system so that the scent containing fluid exiting through the spray device is sprayed onto the filter. A conduit connects the container with the spray device to provide a passage for the flow of the fluid from the container to the spray device. Control means serially connected in the conduit between the container and the spray device controls the flow of the fluid to the spray device. Hence, by operating the control means, the fluid is selectively sprayed on to the filter. The air flowing through the filter picks up the scent and brings the scent to the desired area.

A SECOND EXAMPLE, U.S. Pat. No. 4,306,892, Issued on Dec. 22, 1981, to Atalla et al. teaches a disposable packet, containing an air freshening medium, and formed with securing elements such that the packet may be positioned and retained in an air stream for removing contaminants and offensive odors from the air and discharging a filtered scented fragrance.

A THIRD EXAMPLE, U.S. Pat. No. 4,604,114, Issued on Aug. 5, 1986, to Ward teaches a fragrant scented air filter particularly adapted for use in conjunction with interior building/air conditioning systems which includes a polygonal frame of a U-shaped inwardly opening cross-section defined by a bight portion and a pair of legs, a pad of air permeable, porous, fibrous filtering material having a peripheral edge portion bordered by the frame, and at least two solid rods of fragrant scented material spanning the frame in embedded relationship to the pad and in spaced parallel relationship to each other whereby air can freely pass the same with minimum velocity reduction and maximum fragrance absorption.

A FOURTH EXAMPLE, U.S. Pat. No. 4,875,912, Issued on Oct. 24, 1989, to Fulmer teaches a combination of a furnace filter and a scented evaporant packet inserted in a cut out portion of the filter. The evaporant is contained and wrapped in foil when not in use. Upon partial or entire removal of the foil by a tear tab, the evaporant is exposed to the air flowing in the cold air duct of a furnace—Such as used in dwellings, thereby the entire house may be scented. The secondary purpose of the evaporant is to give an indication of when the filter has to be replaced. This will occur when the scent is no longer evident in the air.

A FIFTH EXAMPLE, U.S. Pat. No. 4,959,087, Issued on Sep. 25, 1990, to Kappernaros teaches a forced air handling system filter including an inwardly opening, channel-shaped peripheral frame from which corresponding peripheral portions of a panel-like filter batt is supported and an elongated bar of scented material is provided and stationarily supported within a pocket of the frame opening inwardly of the inner periphery thereof. The bar includes a scent impervious cover completely enclosing the bar and one longitudinal edge of the bar projects outwardly of the aforementioned pocket toward the remote side of the frame and that portion of the cover disposed over the bar marginal portion includes a tear strip extending longitudinally thereof. The tear strip is adjustably tearable from the remainder of the cover to expose a corresponding portion of the bar for scent release therefrom.

A SIXTH EXAMPLE, U.S. Pat. No. 5,019,352, Issued on May 28, 1991, to Gonzalez teaches a filter element for use with a forced air central heating and cooling system includes a liquid reservoir that is fluidically connected to a plurality of wick elements that are located in the filter media of the filter element. A movable plate includes wick portions and portions that are impervious to fluid, and is moved from a position fully connecting the wick elements to the fluid in the fluid reservoir to a position preventing such fluid connection to control the amount of scent placed into the system.

A SEVENTH EXAMPLE, U.S. Pat. No. 5,087,273, Issued on Feb. 11, 1992, to Ward teaches an air freshening device used in conjunction with an air circulation system of a business or residential building for impregnating the air with an aromatic scent. The device comprises a rectangular envelope made out of an air permeable synthetic mesh containing a plurality of aromatic beads. The envelope has a fastener at one corner. It is affixed to the internal conduit of the air circulation system, preferably to the main air filter for the system. As air passes through the air permeable envelope, the aromatic beads volatize, saturating the air with a fragrant scent. The air is then transferred throughout the building via the normal conduit or duct system.

AN EIGHTH EXAMPLE, U.S. Pat. No. 5,240,487, Issued on Aug. 31, 1993, to Kung teaches a frame that carries a variable flow scent dispenser and supports an air filter. The frame, dispenser and filter are to be inserted as a unit into a forced air heating and/or cooling system duct adjacent to the duct outlet through a floor or wall register. The filter is in the form of a two-ply fibrous sheet with an opening between the plies to receive the frame and dispenser. The filter collects dirt particles borne by the warm air as it leaves the duct and is quickly and easily replaceable. The scent dispenser is a container for scented air freshening material and has apertures through opposite walls, which walls are disposed transversely to the direction of airflow, permitting warm airflow through the container. The warm air will cause evaporation from the scented material and will entrain the vaporous scent and disperse the scent throughout the room. A slide is adjustable to increase or decrease the aggregate area of the apertures in one of the apertured container walls so that the intensity of the air freshening scent carried into the room can be controlled.

A NINTH EXAMPLE, U.S. Pat. No. 5,258,051, Issued on Nov. 2, 1993, to Anderson teaches an air filter for use with a forced air handling system has a pad of air-permeable material held in a bordering frame. The bordering frame has a generally U-shaped cross section, with opposing legs extending a short distance over the edge of the pad of air-permeable material. The legs of the bordering frame have spaced apertures extending through them; and scented material is placed within the frame and located so that air passage through the apertures in the frame passes through the scented material to evaporate or volatilize the scented material and supply it to the filtered air flowing through the filter pad.

A TENTH EXAMPLE, U.S. Pat. No. 5,415,675, Issued on May 16, 1995, to Powers et al.

teaches a fragrance return air filter with an air filter for removing impurities from air being forced through the air filter and at least one fragrant impregnated sponge strip mounted on the air filter, so that a fresh clean scent can mix with the filtered air passing through the sponge strip and the air filter.

AN ELEVENTH EXAMPLE, U.S. Pat. No. 5,547,636, Issued on Aug. 20, 1996, to Vick et al. teaches an air freshening device made from a solution of a polymer and a fragrant material, which is applied to an air permeable substrate. A solid fragrant residue is formed on the substrate. A fragrant material diffuses from the residue for scenting flowing through and about the substrate. The air freshening device includes attaching the substrate to an air filter received in a forced air heating, ventilating, and cooling system.

A TWELFTH EXAMPLE, U.S. Pat. No. 5,698,166, Issued on Dec. 16, 1997, to Vick et al.

teaches an air freshening device made from a solution of a polymer and a fragrant material, which is applied to an air permeable substrate. A solid fragrant residue is formed on the substrate. A fragrant material diffuses from the residue for scenting flowing through and about the substrate. An attachment is provided for attaching the substrate to an air filter received in a forced air heating, ventilating, and cooling system.

A THIRTEENTH EXAMPLE, U.S. Pat. No. 5,820,791, Issued on Oct. 13, 1998, to Canale teaches an air freshening device used in conjunction with an air circulation system of a building for impregnating the air with an aromatic scent. The device comprises a combination integrally-mixed plastic and scent substance formed through a manufacturing process that produces a shape for the scent impregnating device which permits it to be removeably attached to an air filter.

A FOURTEENTH EXAMPLE, U.S. Pat. No. 6,077,336, Issued on Jun. 20, 2000, to Ulrich et al. teaches an air filter system that includes a mechanism for notifying a user when a proper filter replacement period had elapsed that further includes a scenting mechanism for scenting the air flowing through the filter system with a pleasant odor. The air filter system includes a scent impregnated filter element held within a filter element frame provided with a user notification system and multiple scent impregnated strips.

A FIFTEENTH EXAMPLE, U.S. Pat. No. 6,117,218, Issued on Sep. 12, 2000, to Snyder et al. teaches a scenting device for attachment to an air filter in a HVAC system. The scenting device comprises a sheet formed from a material that is substantially impervious to air. The sheet is cut so as to form at least one opening through which the air to be scented flows. The opening is preferably serpentine and defines a plurality of fingers in the sheet. A relatively thick layer of a high viscosity liquid, such as a gel, containing a fragrance is deposited onto the sheet. The device is made by partially cutting through the sheet so as to form a zone of weakness having the shape of the intended opening. After the fragrance-containing material is deposited on the sheet, it is packaged and slipped to the user. The user tears the sheet along the zone of weakness, thereby forming the opening.

A SIXTEENTH EXAMPLE, U.S. Pat. No. 6,126,729, Issued on Oct. 3, 2000, to Smith teaches a portable air filter system having a manually operable spray pump for scenting the air flowing therethrough. The system includes an enclosure having an air inlet and an air outlet, a motor/fan assembly for moving air through the air inlet and out the air outlet, a plurality of air filters disposed between the air inlet and the air outlet, and a manually operable pump in fluid communication with a liquid scented material for scenting the air disposed between the air filters and the air outlet.

A brush is attached to a pair of side walls of a wide portion of the enclosure and spans the air inlet. In use the brush aids in dislodging dust and lint from fabric materials.

A SEVENTEENTH EXAMPLE, U.S. Patent Office Publication No. 2002/0139251, Published on Oct. 2, 2002, to Simmons teaches an air filtration system for vehicles, aircraft and spacecraft includes a filter element for filtering air passing through an air vent thereby cleaning the air of toxic substances such as smog, exhaust fumes, noxious gases, diesel fumes, asphalt odors and many other combustion odors., in addition to emitting an aroma scent of fragrance providing a pleasant smell which will not interfere with the cleaning process of the air. The filter having a size and shape such that the filter element fits across the path of the air passing through the air vent and the structure for removably mounting the filter element on the vehicle in the path of air passing through the air vent so that its cleans the air in the enclosed environment of the cabin of the vehicles.

AN EIGHTEENTH EXAMPLE, U.S. Pat. No. 6,878,057, Issued on Apr. 12, 2005, to Calloura teaches a system for individualized filtering and scenting of the air of individual rooms of a building which is serviced by a ducted central forced air handling system. The system includes a conventional “tri-louvered” ceiling register and a filtering and scenting element designed to be inserted and removed from said register without the necessity of removing the register from attachment to the ceiling. The filtering and scenting element is a filtration media disposed between layers of supporting frame-work.

A NINETEENTH EXAMPLE, U.S. Patent Office Publication No. 2005/0103880, Published on May 19, 2005, to Taite teaches an air filter assembly includes a perimeter frame supporting an air filtering medium. The perimeter frame defines a cavity holding scented material, and defines apertures that face the air filtering medium, but that are not directly subject to flow-through of air. A cover or tape is adjustable to selectively partially uncover the apertures, thus providing control of the scenting process. By this arrangement, air is scented but the scented material is longer-lasting since it is drawn out of the cavity rather than being blown out or evaporated by high flow of air. Further, the scenting process is controllable by selectively removing the cover or tape, or by selectively positioning of the cover. In some versions, the scented material is replaceable. In another version, the arrangement is attachable to a conventional filter assembly.

A TWENTIETH EXAMPLE, U.S. Patent Office Publication No. 2005/0169813, Published on Aug. 4, 2005, to D'Amico et al. teaches an air freshener filter insert for use with the air filter in a motor vehicle air conditioning, air ventilating systems. The air freshener filter insert is a strip of permeable material such as a mesh which may be formed having pockets spaced apart from one another longitudinally there along. The pockets contain a selected quantity of a solid particulate material impregnated with a time release substance of selected fragrance. A length portion of the air freshener strip is cut to match the length of a replacement air filter and then mounted on a face thereof. The combined unit is then installed in the vehicle ventilating system. Servicing of the air filter can readily be done at quick lube service stations.

A TWENTY-FIRST EXAMPLE, U.S. Patent Office Publication No. 2006/0005711, Published on Jan. 12, 2006, to Olefson teaches a replaceable air filter for a vehicle air conditioning system employs a pleated, porous filter media coated with a perfume polymer composition to impart a long-lasting scent to air passing through the filter. In alternative embodiments of the invention the perfume/polymer composition is contained in a sheet overlying the filter material, in the frame or in a bead supported by the filter.

A TWENTY-SECOND EXAMPLE, U.S. Patent Office Publication No. 2006/0110297, Published on May 25, 2006, to D'Amico et al. teaches an air freshener filter insert for use with the air filter in a motor vehicle air conditioning, air ventilating systems. The air freshener filter insert is a strip of permeable material such as a mesh which may be formed having pockets spaced apart from one another longitudinally there along. The pockets contain a selected quantity of a solid particulate material impregnated with a time release substance of selected fragrance. A length portion of the air freshener strip is cut to match the length of a replacement air filter and then mounted on a face thereof. The combined unit is then installed in the vehicle ventilating system. Servicing of the air filter can readily be done at quick lube service stations.

A TWENTY-THIRD EXAMPLE, U.S. Patent Office Publication No. 2007/0140924, Published on Jun. 21, 2007, to Hill teaches a maintenance free automatic odor control system comprises a flow through fabric sheet having an attachment end to attach to a forced air heating and cooling register. The attachment end may be a magnetic strip of it may be half of a Velcro® pull with the other half mounted on the register. As air is forced through the register, the scent is dispersed throughout the room. Additionally, the fabric is porous and also filters particulates and other impurities from being released into the room by capturing them in the weave of the fabric. The sheets are disposable and are simply replaced and discarded when no longer effective. Because the filter fabric is chosen to be aesthetically pleasing, otherwise unattractive registers may be hidden.

A TWENTY-FOURTH EXAMPLE, U.S. Patent Office Publication No. 2009/0078119, Published on Mar. 26, 2009, to Buckley teaches a filter system including a frame with a central filtration portion is provided for delivery of volatile materials to the atmosphere to be filtered. Upon contact of a fluid to be filtered, a volatile or aromatic material is transferred to the incoming fluid so as to scent or condition the filtered fluid.

A TWENTY-FIFTH EXAMPLE, U.S. Patent Office Publication No. 2010/0186594, Published on Jul. 29, 2010, to Gelo teaches a scented furnace filter assembly. The scented furnace filter assembly comprises a frame that has a filter screen therein.

A wick is installed inside of the frame and has a scent that emits therefrom wherein the wick is sealed until use. Once ready for use the seal is removed and the scent emits from the wick to provide scented air through a furnace and throughout a home or building.

A TWENTY-SIXTH EXAMPLE, U.S. Pat. No. 7,776,276, Issued on Aug. 17, 2010, to Newbolt teaches an air filtering system for a vehicle includes a housing having a fan, a HEPA filter, a carbon-impregnated military cloth and a scent dispersing mechanism received therein. Air intake modules are positioned at desired locations within the vehicle passenger compartment, each of which is in communication with the housing interior. To remove smoke or other pollutants, a passenger activates the fan to deliver ambient air to the housing interior whereby the HEPA filter removes particles while the charcoal cloth removes entrained odors. The housing also includes a fragrance dispenser for dispersing a scented material, if desired.

It is apparent now that numerous innovations for air freshening systems have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a scented air filter that avoids the disadvantages of the prior art.

ANOTHER OBJECT of the present invention is to provide a scented air filter that is simple and inexpensive to manufacture.

STILL ANOTHER OBJECT of the present invention is to provide a scented air filter that is simple to use.

BRIEFLY STATED, STILL YET ANOTHER OBJECT of the present invention is to provide a scented air filter which comprises a frame member. A central fibrous filtering material pad is carried within the frame member. A pair of infused fragrance pads are sandwiched between the central fibrous filtering material pad. A pair of backing sheets are provided. Each sheet has a plurality of circular openings to allow forced air therethrough. Each sheet is placed over one of the infused fragrance pads to prevent deflection and defibrillation thereof, whereby the forced air can absorb the fragrance from the fragrance pads.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view of the present invention;

FIG. 2 is an enlarged cross sectional view taken along ling 2-2 in FIG. 1;

FIG. 3 is a perspective view showing a person replacing a regular air filter in a heat exchanger system with the present invention; and

FIG. 4 is a perspective view showing good smelling scented air filters in a vehicle ventilation's system.

### REFERENCE NUMERALS UTILIZED IN THE DRAWINGS

110 scented air filter
112 frame member of filter 110
114 central fibrous filtering material pad of filter 110
116a-b infused fragrance pads of filter 110
118a-b backing sheets of filter 110
120a-b circular openings in backing sheets 118a-b
122a-b cylindrical bores in central fibrous filtering material pad 114
124a-b cylindrical projections of infused fragrance pads 116a-b
126a-b peel-off covers of filter 110
128a-b layer of adhesive material of cover 126
130 plastic material for frame member 112

### DETAILED DESCRIPTION OF THE PREFERRED EMBODIMENT

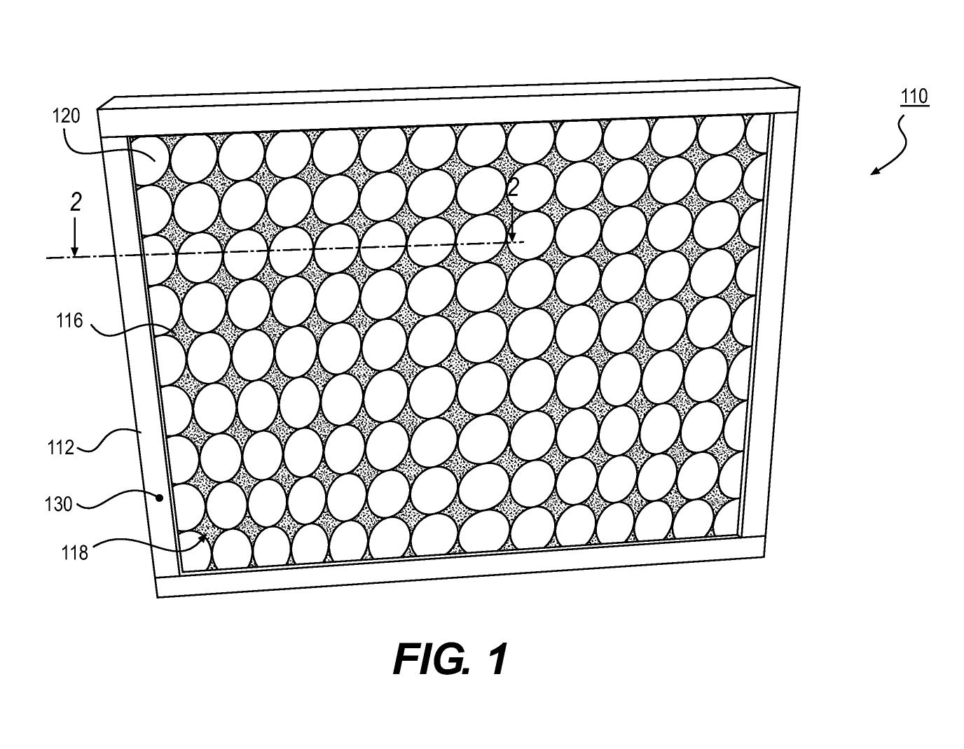

As shown in FIG. 1, the present invention is a scented air filter 110 which comprises a plastics frame member 112. A central fibrous filtering material pad 114 is carried within the frame member 112.

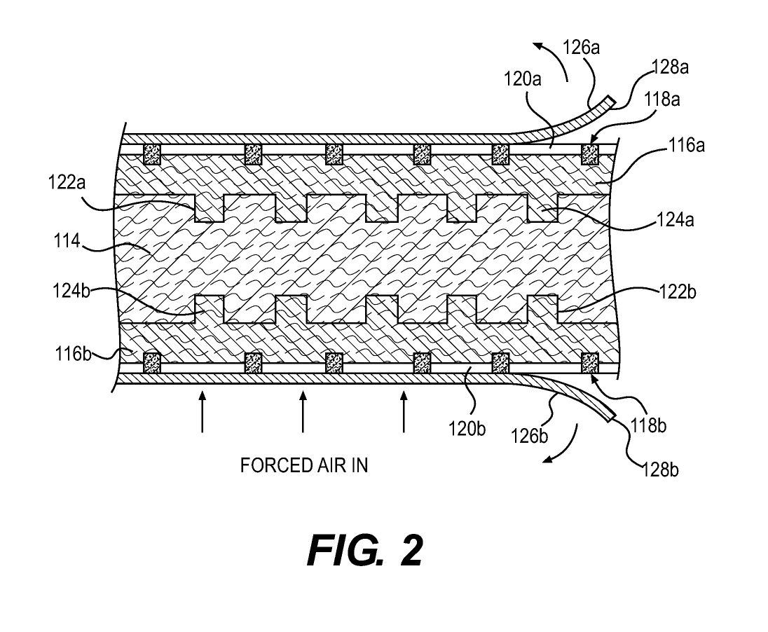

In FIG. 2, the central fibrous filtering material pad 114 is sandwiched between a pair of infused fragrance pads 116a-b. A pair of backing sheets 118a-b is layered on top of the pair of infused fragrance pads 116a-b. Each sheet 118a-b has a plurality of circular openings 120a-b to allow forced air therethrough. Each sheet 118a-b is placed over one of the infused fragrance pads 116a-b to prevent deflection and defibrillation thereof, whereby the forced air can absorb the fragrance from the fragrance pads 116a-b.

The central fibrous filtering material pad 114 has a plurality of cylindrical bores 122a-b on each side thereof being in alignment with the circular openings 120a-b in the backing sheets 118a-b. Each infused fragrance pad 116a-b has a plurality of cylindrical projections 124a-b which are sized to fit into the cylindrical bores 122a-b in the central fibrous filtering material pad 114 to increase infusion of the fragrance.

The scented air filter 110 further comprises a pair of peel-off covers 126a-b. Each cover 126a-b has a layer of adhesive material 128a-b placed against and seals each backing sheet 118a-b when not in use.

The fragrance in each infused fragrance pad 116a-b is a scent selected from the group consisting of sungreene (pine), Tropicana, vanilla neutralizer, honeysuckle blossom, caramel, twist o'lime, vanilla swirl and vanilla bean. The fragrance in the pair of infused fragrance pads 116a and 116b can be the same. The fragrance in the pair of infused fragrance pads 116a and 116b can also be different based on user's selection or customization. The frame member 112 is fabricated out of a plastic material 130.

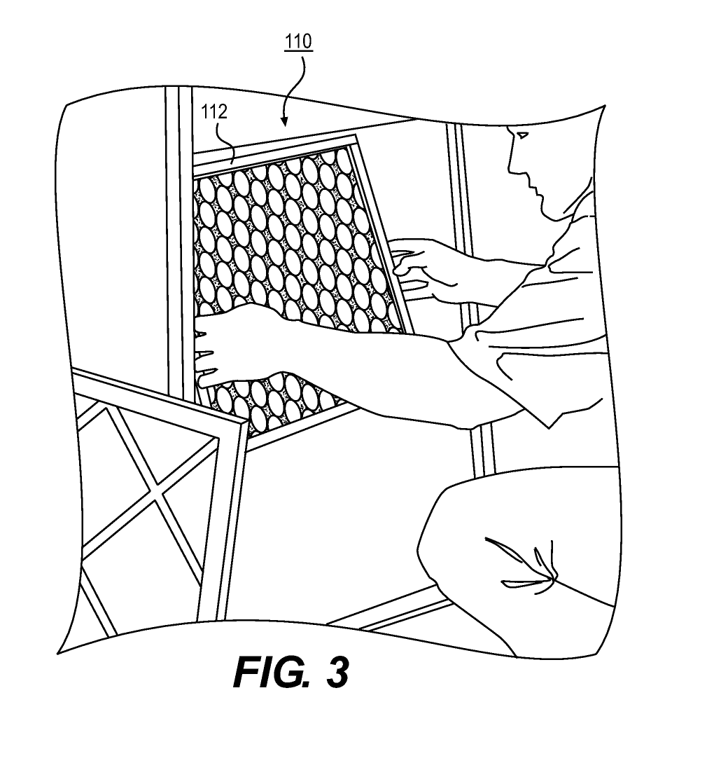

In FIG. 3, the scented air filter 110 freshens the air distributed into a building or a house. The present invention works in conjunction with a current air conditioning system. The scented air filter 110 may be produced in a variety of sizes to fit various sizes and types of units. The present invention performs the same filtration duties as a normal A/C filter. However, it is infused with a double fragrance pads so that a pleasant scent is distributed throughout the vents in a home or building as the air blows through the scented air filter 110. The present invention may be available in a variety of colors and scents. The frame member 112 of the scented air filter 110 may be made in various colors if desired.

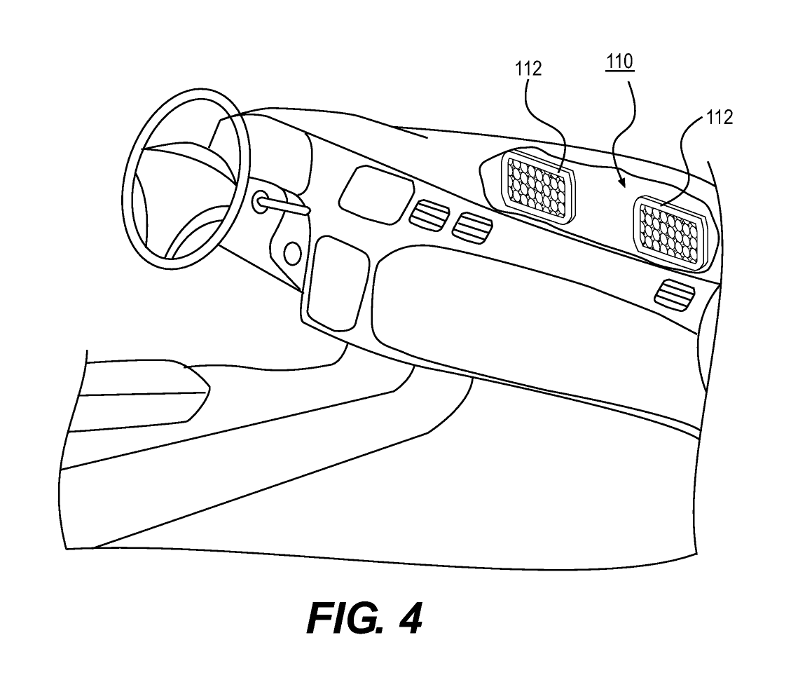

In FIG. 4: the filter 110 may also be applied to a motor vehicle's ventilation system. The exact specifications may vary.

It will be understood that each of the elements described above, or two or more together, may also find a useful application in other types of constructions differing from the types described above.

While the invention has been illustrated and described as embodiments of a scented air filter, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A scented air filter used in a forced air system which comprises:
a) a frame member;
b) a central fibrous filtering material pad carried within the frame member;
c) a pair of infused fragrance pads sandwiched on both sides of the central fibrous filtering material pad; and
d) a pair of backing sheets, each sheet having a plurality of circular openings to allow forced air therethrough, each sheet placed over one of the infused fragrance pads to prevent deflection and defibrillation thereof, whereby the forced air can absorb the fragrance from the infused fragrance pads.

2. The scented air filter as recited in claim 1, further comprising:
a) the central fibrous filtering material pad having a plurality of cylindrical bores on each side thereof being in alignment with the circular openings in the backing sheets; and
b) each infused fragrance pad having a plurality of cylindrical projections which are sized to fit into the cylindrical bores on both size of the central fibrous filtering material pad to increase infusion of the fragrance.

3. The scented air filter as recited in claim 1, further comprising a pair of peel-off covers, each cover having a layer of adhesive material placed against and seals each backing sheet when not in use.

4. The scented air filter as recited in claim 1, wherein the fragrance in each infused fragrance pad is a scent selected from the group consisting of sungreene (pine), Tropicana, vanilla neutralizer, honeysuckle blossom, caramel, twist o'lime, vanilla swirl and vanilla bean.

5. The scented air filter as recited in claim 1, wherein the fragrance in the pair of infused fragrance pads are the same.

6. The scented air filter as recited in claim 1, wherein the fragrance in the pair of infused fragrance pads are different based on user's selection.

7. The scented air filter as recited in claim 1, wherein the frame member is fabricated out of a plastic material.

8. The scented air filter as recited in claim 1 can be used in the forced air system of a building.

9. The scented air filter as recited in claim 1 can be used in the forced air system of a vehicle.
